(19) United States
(12) Patent Application Publication
(10) Pub. No.: US 2011/0158588 A1
(43) Pub. Date: Jun. 30, 2011

(54) CABLE ASSEMBLY HAVING FLOATABLE OPTICAL MODULE

(75) Inventors: TERRANCE F. LITTLE, York, PA (US); STEPHEN SEDIO, Valley Center, CA (US)

(73) Assignee: HON HAI PRECISION INDUSTRY CO., LTD., Tu-Cheng (TW)

(21) Appl. No.: 12/647,411

(22) Filed: Dec. 25, 2009

(51) Int. Cl. G02B 6/38

(52) U.S. Cl. 385/74; 385/55; 385/75

(57) ABSTRACT

A cable assembly (100) includes an insulative housing (2) having a mounting cavity (221); an optical module (5) accommodated in the mounting cavity and capable of moving therein along a front-to-back direction; at least one fiber (6) coupled to the optical module; and two coil springs (9) spaced away from each other along a transversal direction and located behind the optical module to bias the optical module.

### CROSS-REFERENCE TO RELATED APPLICATIONS

This application is related to U.S. patent application Ser. No. 11/818,100, filed on Jun. 13, 2007 and entitled “EXTENSION TO UNIVERSAL SERIAL BUS CONNECOTR WITH IMPROVED CONTACT ARRANGEMENT”, and U.S. patent application Ser. No. 11/982,660, filed on Nov. 2, 2007 and entitled “EXTENSION TO ELECTRICAL CONNECTOR WITH IMPROVED CONTACT ARRANGEMENT AND METHOD OF ASSEMBLING THE SAME”, and U.S. patent application Ser. No. 11/985,676, filed on Nov. 16, 2007 and entitled “ELECTRICAL CONNECTOR WITH IMPROVED WIRE TERMINATION”, and U.S. patent application Ser. No. 12/626,632 filed on Nov. 26, 2009 and entitled “CABLE ASSEMBLY HAVING POSITIONING MEANS SECURING FIBER THEREOF”, and U.S. patent application Ser. No. 12/626,631 filed Nov. 26, 2009 and entitled “CABLE ASSEMBLY HAVING POSITIONING MEANS SECURING FIBER THEREOF”, and U.S. patent application Ser. No. 12/636,775 filed Dec. 13, 2009 and entitled “CABLE ASSEMBLY HAVING FLOATABLE OPTICAL MODULE”, and U.S. patent application Ser. No. 12/636,774 filed Dec. 13, 2009 and entitled “CABLE ASSEMBLY HAVING FLOATABLE OPTICAL MODULE”, all of which have the same assignee as the present invention.

### BACKGROUND OF THE INVENTION

1. Field of the Invention

The present invention relates to a cable assembly, more particularly to a cable assembly capable of transmitting optical signal.

2. Description of Related Art

Recently, personal computers (PC) are used of a variety of techniques for providing input and output. Universal Serial Bus (USB) is a serial bus standard to the PC architecture with a focus on computer telephony interface, consumer and productivity applications. The design of USB is standardized by the USB Implementers Forum (USB-IF), an industry standard body incorporating leading companies from the computer and electronic industries. USB can connect peripherals such as mouse devices, keyboards, PDAs, gamepads and joysticks, scanners, digital cameras, printers, external storage, networking components, etc. For many devices such as scanners and digital cameras, USB has become the standard connection method.

USB supports three data rates: 1) A Low Speed rate of up to 1.5 Mbit/s (187.5 KB/s) that is mostly used for Human Interface Devices (HID) such as keyboards, mice, and joysticks; 2) A Full Speed rate of up to 12 Mbit/s (1.5 MB/s). Full Speed was the fastest rate before the USB 2.0 specification and many devices fall back to Full Speed. Full Speed devices divide the USB bandwidth between them in a first-come first-served basis and it is not uncommon to run out of bandwidth with several isochronous devices. All USB Hubs support Full Speed; 3) A Hi-Speed rate of up to 480 Mbit/s (60 MB/s). Though Hi-Speed devices are advertised as “up to 480 Mbit/s”, not all USB 2.0 devices are Hi-Speed. Hi-Speed devices typically only operate at half of the full theoretical (60 MB/s) data throughput rate. Most Hi-Speed USB devices typically operate at much slower speeds, often about 3 MB/s overall, sometimes up to 10-20 MB/s. A data transmission rate at 20 MB/s is sufficient for some but not all applications. However, under a circumstance transmitting an audio or video file, which is always up to hundreds MB, even to 1 or 2 GB, currently transmission rate of USB is not sufficient. As a consequence, faster serial-bus interfaces are being introduced to address different requirements. PCI Express, at 2.5 GB/s, and SATA, at 1.5 GB/s and 3.0 GB/s, are two examples of High-Speed serial bus interfaces.

From an electrical standpoint, the higher data transfer rates of the non-USB protocols discussed above are highly desirable for certain applications. However, these non-USB protocols are not used as broadly as USB protocols. Many portable devices are equipped with USB connectors other than these non-USB connectors. One important reason is that these non-USB connectors contain a greater number of signal pins than an existing USB connector and are physically larger as well. For example, while the PCI Express is useful for its higher possible data rates, a 26-pin connectors and wider card-like form factor limit the use of Express Cards. For another example, SATA uses two connectors, one 7-pin connector for signals and another 15-pin connector for power. In essence, SATA is more useful for internal storage expansion than for external peripherals.

The existing USB connectors have a small size but low transmission rate, while other non-USB connectors (PCI Express, SATA, et al) have a high transmission rate but large size. Neither of them is desirable to implement modern high-speed, miniaturized electronic devices and peripherals. To provide a kind of connector with a small size and a high transmission rate for portability and high data transmitting efficiency is much more desirable.

In recent years, more and more electronic devices are adopted for optical data transmission. It may be a good idea to design a connector which is capable of transmitting an electrical signal and an optical signal. Design concepts are already common for such a type of connector which is compatible of electrical and optical signal transmission. The connector includes metallic contacts assembled to an insulated housing and several optical lenses bundled together and mounted to the housing also. A kind of hybrid cable includes wires and optical fibers that are respectively attached to the metallic contacts and the optical lenses.

However, optical lenses are unable to float within the housing if they are not accurately aligned with, and optically coupled to counterparts, and if there are some errors in the manufacturing process.

### BRIEF SUMMARY OF THE INVENTION

Accordingly, an object of the present invention is to provide a cable assembly that has a floatable optical module.

In order to achieve the above-mentioned object, a cable assembly in accordance with present invention comprises an insulative housing defining a mounting cavity; an optical module accommodated in the mounting cavity and capable of moving therein along a front-to-back direction; at least one fiber coupled to the optical module; and two coil springs spaced away from each other along a transversal direction and located behind the optical module to bias the optical module.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an assembled, perspective view of a cable assembly in accordance with the first embodiment of the present invention;

FIG. 2 is an exploded, perspective view of FIG. 1;

FIG. 3 is similar to FIG. 2, but viewed from another aspect;

FIG. 4 is a partially assembled view of the cable assembly;

FIG. 5 is other partially assembly view of the cable assembly; and

FIG. 6 is enlarged view of two resilient members.

### DETAILED DESCRIPTION OF THE PREFERRED EMBODIMENTS

In the following description, numerous specific details are set forth to provide a thorough understanding of the present invention. However, it will be obvious to those skilled in the art that the present invention may be practiced without such specific details.

Reference will be made to the drawing figures to describe the present invention in detail, wherein depicted elements are not necessarily shown to scale and wherein like or similar elements are designated by same or similar reference numeral through the several views and same or similar terminology.

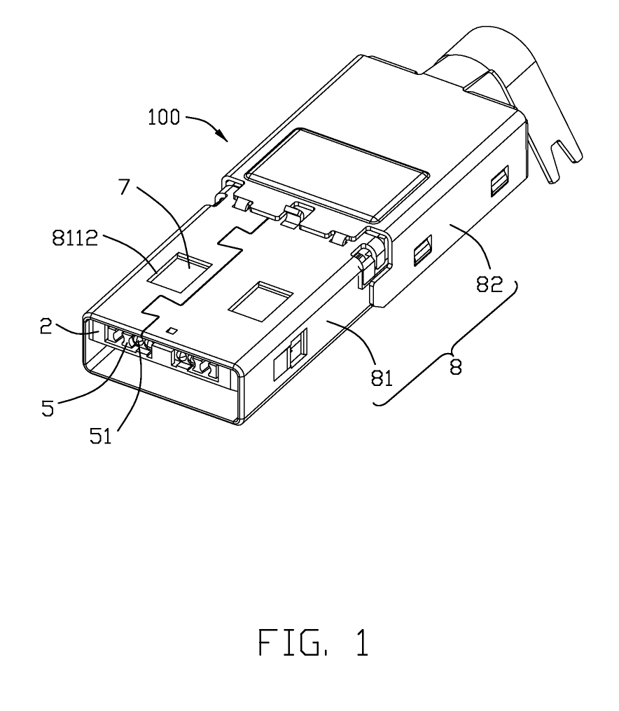

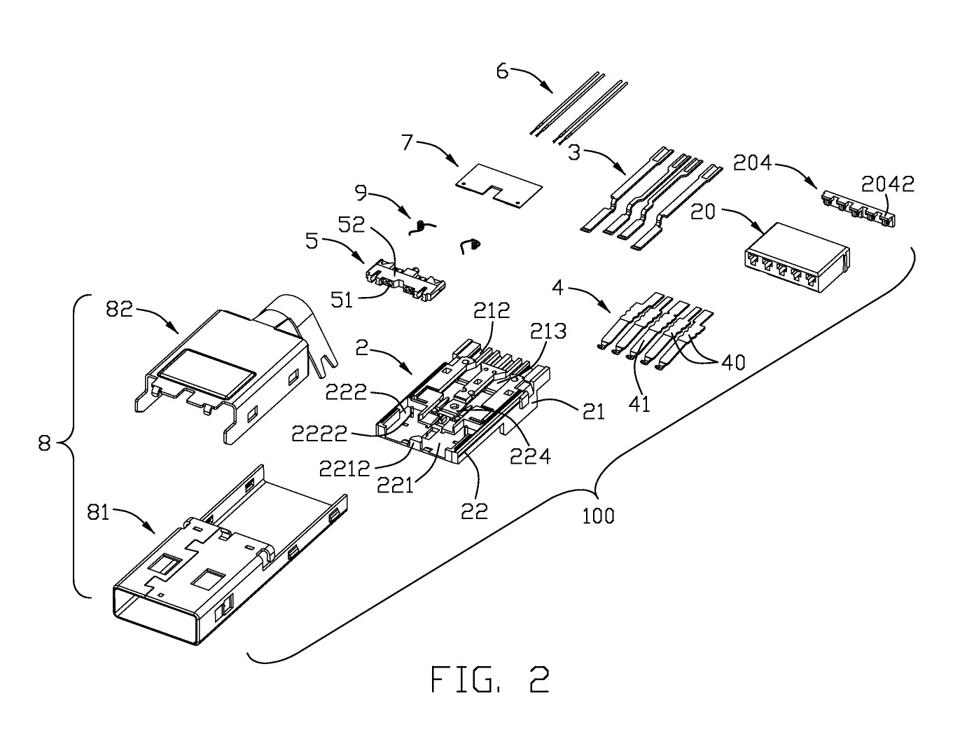

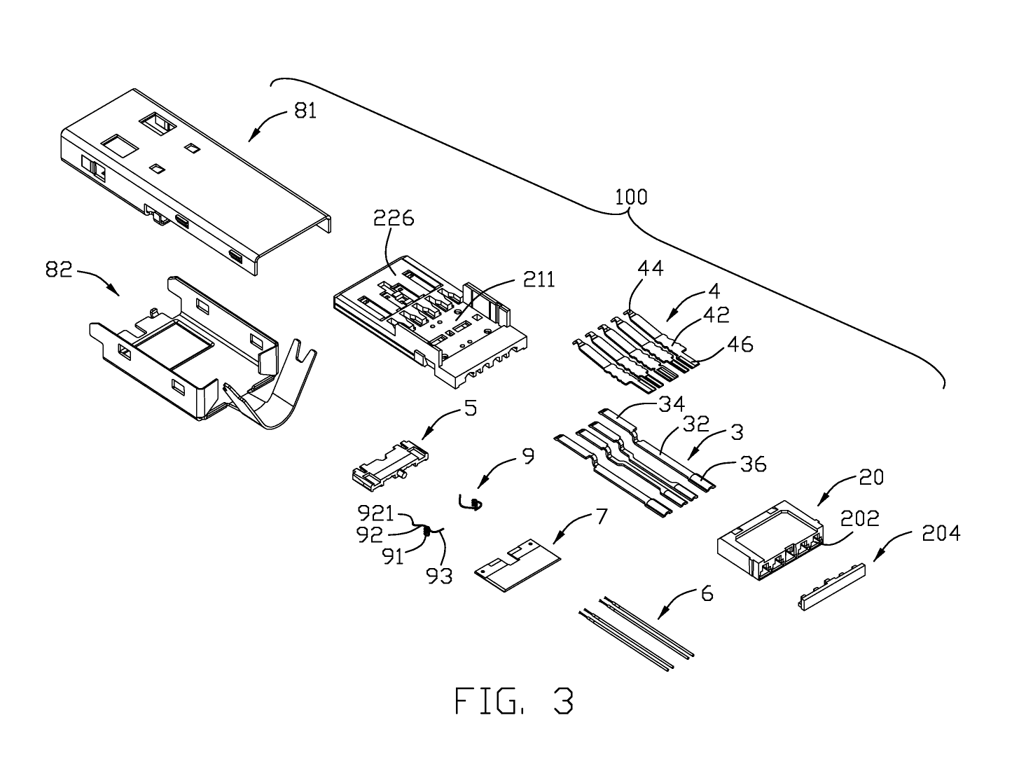

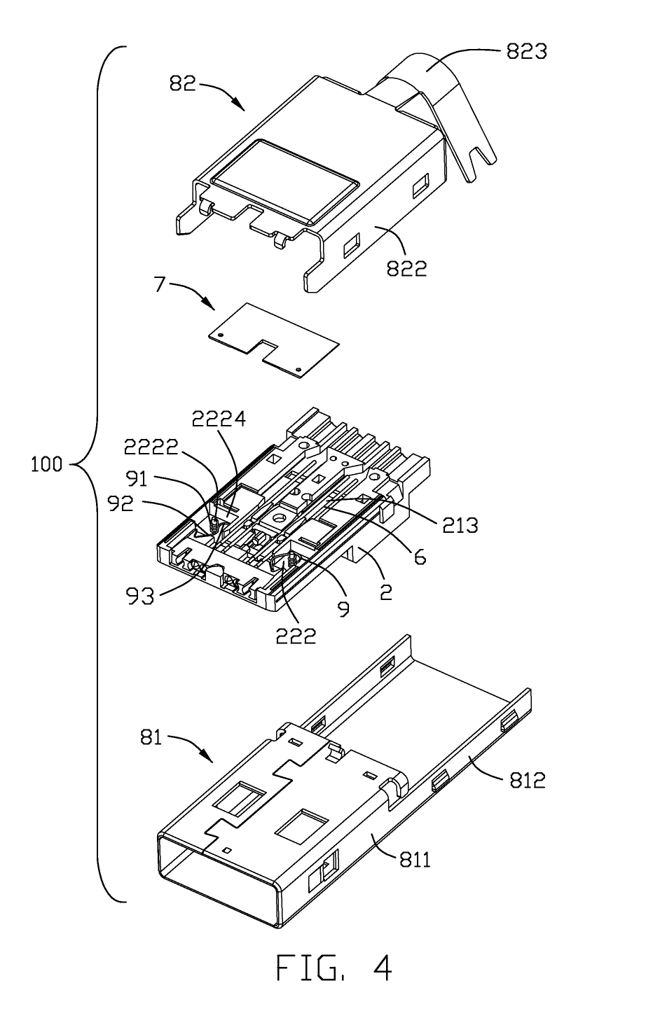

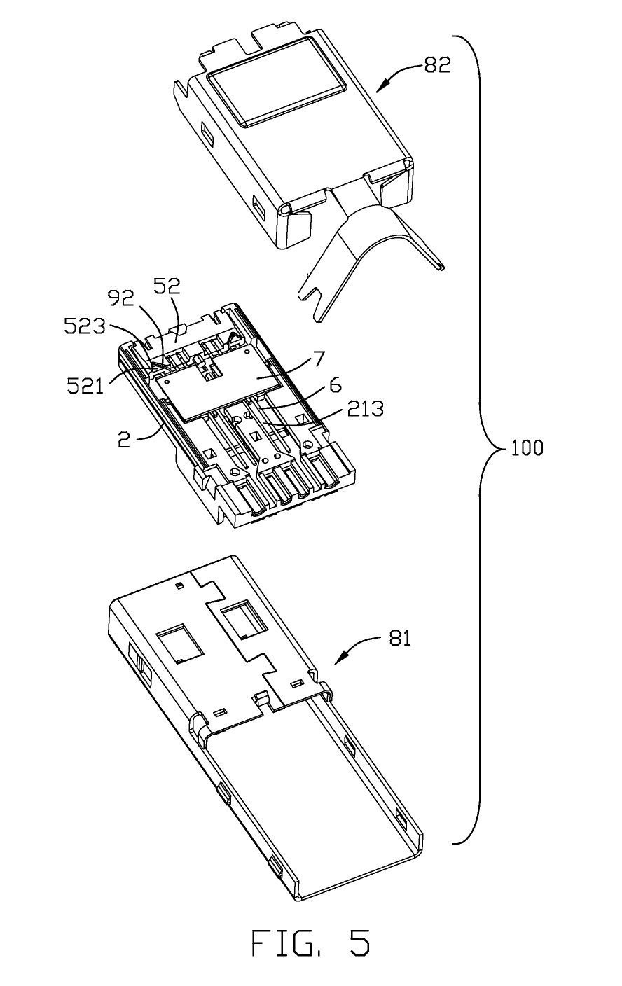

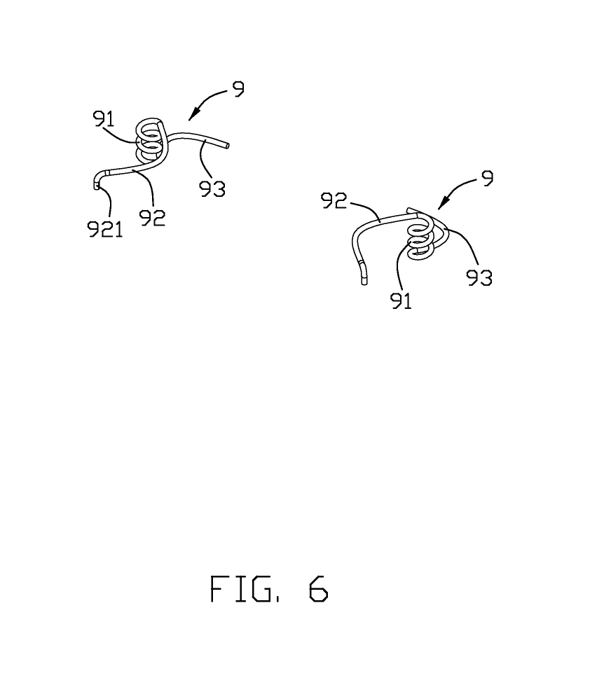

Referring to FIGS. 1-6, a cable assembly 100 according to the present invention is disclosed. The cable assembly 100 comprises an elongated insulative housing 2 extending along a front-to-back direction, a set of first contacts 3, a set of second contacts 4 and an optical modules 5 supported by the insulative housing 2, and a number of fibers 6 coupled to the optical module 5. The cable assembly 1 further comprises a cap member 7, a metal shell 8 and two resilient members 9 spaced apart from each other along a transversal direction perpendicular to the front-to-back direction. The resilient members 9 are capable of biasing the optical modular 5 along the front-to-back direction. Detail description of these elements and their relationship and other elements formed thereon will be detailed below.

The insulative housing 2 includes a base portion 21 and a tongue portion 22 extending forwardly from the base portion 21. A cavity 211 is recessed upwardly from a bottom surface (not numbered) of the base portion 21. A mounting cavity 221 is recessed downwardly from a top surface of the tongue portion 22. A stopping member 2212 is formed in a front portion of the mounting cavity 221. A pair of positioning slots 222 are defined in lateral sides of the tongue portion 22 and located behind and communicating with the mounting cavity 221. A depression 224 is defined in a rear portion of the tongue portion 22 and communicating with the mounting cavity 221. A number of contact slots 212 are defined in an upper segment of a rear portion of the base portion 21. Two fiber grooves 213 are defined in the base portion 21 and extend along the front-to-back direction, pass the depression 224 and communicate with the mounting cavity 221. Each positioning slot 222 is rectangular shaped viewed from a top side. An upright shaft/post 2222 is formed in a center of the each positioning slot 222.

The set of first contacts 3 have four contact members arranged in a row along the transversal direction. Each first contact 3 substantially includes a planar retention portion 32 supported by a bottom surface of the cavity 211, a mating portion 34 raised upwardly and extending forwardly from the retention portion 32 and disposed in a depression 226 of the lower section of the front segment of the tongue portion 22, and a tail portion 36 extending rearward from the retention portion 32 and accommodated in the terminal slots 212.

The set of second contacts 4 have five contact members arranged in a row along the transversal direction and combined with an insulator 20. The set of second contacts 4 are separated into two pairs of signal contacts 40 for transmitting differential signals and a grounding contact 41 disposed between the two pair of signal contacts 40. Each signal contact 4 includes a planar retention portion 42 received in corresponding groove 202 in the insulator 20, a curved mating portion 44 extending forward from the retention portion 42 and disposed beyond a front surface of the insulator 20, and a tail portion 46 extending rearward from the retention portion 42 and disposed behind a back surface of the insulator 20. A spacer 204 is assembled to the insulator 20, with a number of ribs 2042 thereof inserted into the grooves 202 to position the second contacts 4 in the insulator 20.

The insulator 20 is mounted to the cavity 211 of the base portion 21 and press onto retention portions 32 of the first contacts 3, with mating portions 44 of the second contacts 4 located behind the mating portions 34 of the first contacts 3 and above the up surface of the tongue portion 22, the tail portions 46 of the second contacts 4 arranged on a bottom surface of the rear segment of the base portion 21 and disposed lower than the tail portions 36 of the first contacts 3.

The optical module 5 includes four lens members 51 arranged in juxtaposed manner and enclosed by a holder member 52 and retained in the mounting cavity 221. Two positioning cavities 521 are defined in lateral sections of a top side of the holder member 52. In addition, a positioning hole 523 is defined in each of the two positioning cavities 521.

The two resilient members 9 are coil springs which are made from spring wire material. Each resilient member 9 has a coiled resilient portion 91, a first arm 92 extending forwardly from an upper end of the resilient portion 91, and a second arm 93 extending rearwardly from a lower end of the resilient portion 91. Therefore, the first arm 92 is located above the resilient portion 91 and the second arm 93. A hook 921 is formed at a front end of the first arm 92. Each of the two resilient members 9 are mounted to the corresponding positioning slot 222, with the shaft 2222 extending into resilient portion 91, the first arm extending into the positioning cavity 521 of the holder member 52, and the hook 921 locking into the positioning hole 523, the second arm 93 disposed in close proximity to a bottom side of the positioning slot 222 and further abutting against a back side 2224 of the positioning slot 222. Thus, the resilient members 9 press onto the holder member 52 and are capable of biasing the optical module 5 movement in the mounting cavity 221 along the front-to-back direction.

Four fibers 6 are separated into two groups and enter a rear section of the mounting cavity 221, through the fiber grooves 213 and are coupled to the four lens 51, respectively. The cap member 7 is assembled to the depression 224 and the positioning slots 222. Therefore the fibers 6 are confined in the fiber grooves 213, and they are unable to drift freely in the mounting cavity 221. Furthermore, the second arm 93 and resilient portion 91 of the resilient members 9 are covered by the cap member 7 and positioned in the positioning slots 222.

The metal shell 8 comprises a first shield part 81 and a second shield part 82. The first shield part 81 includes a front tube-shaped mating frame 811, a rear U-shaped body section 812 connected to a bottom side and lateral sides of the mating frame 811. The mating frame 811 further has two windows 8112 defined in a top side thereof. The second shield part 82 includes an inverted U-shaped body section 822, and a cable holder member 823 attached to a top side of the body section 822.

The insulative housing 2 is assembled to the first shield part 81, with the tongue portion 22 enclosed in the mating frame 811, the cap member 7 arranged underneath the two windows 8112, and the base portion 21 is received in the body portion 812. The second shield part 82 is assembled to the first shield part 81, with body portions 822, 812 combined together. The cable assembly may have a hybrid cable which includes fibers 6 for transmitting optical signals and copper wires (not shown) for transmitting electrical signals. The copper wires are terminated to the first contacts 3 and the second contacts 4. The cable holder member 823 is crimped onto the cable to enhance mechanical interconnection.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. For example, the tongue portion is extended in its length or is arranged on a reverse side thereof opposite to the supporting side with other contacts but still holding the contacts with an arrangement indicated by the broad general meaning of the terms in which the appended claims are expressed.

We claim:

1. A cable assembly, comprising:
an insulative housing defining a mounting cavity;
an optical module accommodated in the mounting cavity and capable of moving therein along a front-to-back direction;
at least one fiber coupled to the optical module; and
two coil springs spaced away from each other along a transversal direction and located behind the optical module in said front-to-back direction to bias the optical module.

2. The cable assembly as claimed in claim 1, wherein each coil spring is mounted to a corresponding positioning slot which is defined in the insulative housing and located behind the mounting cavity.

3. The cable assembly as claimed in claim 2, wherein the coil spring includes a coiled resilient portion, a first arm extending forwardly from an upper end of the resilient portion, and a second arm extending rearwardly from a lower end of the resilient portion.

4. The cable assembly as claimed in claim 3, wherein a post is arranged in the positioning slot and inserted into the coiled resilient portion.

5. The cable assembly as claimed in claim 3, wherein the first arm projects into the mounting cavity and presses onto the optical module.

6. The cable assembly as claimed in claim 5, wherein the first arm has a hook locking into a positioning hole defined in the optical module.

7. The cable assembly as claimed in claim 3, wherein the second arm presses onto a back side of the positioning slot.

8. The cable assembly as claimed in claim 1, further comprising a cap member assembled to the insulative housing and covering the at least one fiber.

9. The cable assembly as claimed in claim 8, wherein the cap member partially covers the two coil springs.

10. The cable assembly as claimed in claim 8, wherein a metal shell encloses the insulative housing and the cap member therein.

11. The cable assembly as claimed in claim 9, wherein the cap member is arranged underneath multiple windows which are defined in the metal shell.

12. The cable assembly as claimed in claim 1, wherein a corresponding fiber groove is defined in the insulative housing and communicates with the mounting cavity, and the at least one fiber passes through the fiber groove and extends into the mounting cavity.

13. The cable assembly as claimed in claim 1, further comprising a plurality of contacts supported by the insulative housing.

14. The cable assembly as claimed in claim 13, wherein the contacts are divided into a set of first contacts and a set of second contacts.

15. The cable assembly as claimed in claim 14, wherein mating portions of the first contacts are spaced apart from mating portions of the second contacts along the front-to-back direction.

16. The cable assembly as claimed in claim 14, wherein mating portions of the first and second contacts and the optical module are disposed opposite sides of a tongue portion of the insulative housing.

17. The cable assembly as claimed in claim 14, wherein the first contacts are mounted to the insulative housing directly, and the second contacts are combined with an insulator and mounted to the insulative housing.

18. A cable connector assembly comprising:
an insulative housing defining a mating port communicating with an exterior in a front-to-back direction;
a mating face located beside the mating port and facing toward said mating port in a vertical direction perpendicular to said front-to-back direction;
a plurality of contacts disposed in the housing with contacting sections exposed upon the mating face;
an optical module hidden behind the mating face in the vertical direction while with lenses exposed to the exterior in said front-to-back direction; and
a torsion spring compliantly engaging a post formed on one of said housing and said optical module; wherein
said torsion spring defines a torsion main body with two opposite ends respectively abutting against the optical module and the housing to constantly urge said optical module forwardly.

19. The cable connector assembly as claimed in claim 18, wherein said torsion spring surrounds said post.

20. A cable connector assembly comprising:
an insulative housing defining a mating port communicating with an exterior in a front-to-back direction;
a mating face located beside the mating port and facing toward said mating port in a vertical direction perpendicular to said front-to-back direction;
a plurality of contacts disposed in the housing with contacting sections exposed upon the mating face;
an optical module hidden behind the mating face in the vertical direction while with lenses exposed to the exterior in said front-to-back direction; and
a torsion spring having a torsion main body with at least one arm extending forwardly to constantly contact and urge the optical module forwardly.
